(19) United States
(12) Patent Application Publication
(10) Pub. No.: US 2026/0173105 A1
(43) Pub. Date: Jun. 18, 2026

(54) UPPER LAYER SIGNALING FOR PHYSICAL LAYER CONTROL INFORMATION

(71) Applicant: QUALCOMM Incorporated, San Diego, CA (US)

(72) Inventors: Jing SUN, San Diego, CA (US); Mostafa KHOSHNEVISAN, San Diego, CA (US); Yu ZHANG, San Diego, CA (US); Gabi SARKIS, San Diego, CA (US); Jing JIANG, San Diego, CA (US); Junyi LI, Greentown, PA (US); Linhai HE, San Diego, CA (US); Qing LI, PRINCETON JUNCTION, NJ (US); Yi HUANG, San Diego, CA (US)

(21) Appl. No.: 18/983,991

(22) Filed: Dec. 17, 2024

(51) Int. Cl. H04W 72/231; H04W 72/232

(52) U.S. Cl. CPC H04W 72/231; H04W 72/232

(57) ABSTRACT

Wireless communication systems and methods for transmitting and receiving physical layer control information using upper-layer signaling are described. In one aspect, a method performed by a first wireless communication device comprises receiving, from a second wireless communication device, physical layer signaling, and transmitting, to the second wireless communication device, a Medium Access Control (MAC) layer control message. In one aspect, the MAC layer control message comprises physical layer control information associated with a first physical layer message type. In another aspect, the physical layer control information is generated based on the physical layer signaling. In another aspect, the MAC layer control message indicates a MAC layer control message type, the MAC layer control message type being associated with the first physical layer message type.

### TECHNICAL FIELD

This application relates to wireless communication systems, and more particularly to upper layer signaling such as the use of Medium Access Control (MAC) layer control message structures and methods for communicating physical layer control information.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHZ to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes schemes and mechanisms for transmitting physical layer control information using upper layer signaling. For example, a Medium Access Control (MAC) layer of the Open Systems Interconnection (OSI) model may be used for carrying physical layer control information. In some aspects, physical layer control information may be transmitted through a MAC control message. In one example, the MAC control message may include a MAC-Control Element (MAC-CE). For instance, physical control layer information may include a Hybrid Automatic Repeat Request (HARQ) Acknowledgement/Non-Acknowledgement (ACK/NACK) codebook, a Channel State Information (CSI) report, or any other suitable type of physical layer control information that is used for the control of physical layer procedures. In conventional approaches, such information may be transmitted as a physical layer message on one or more physical layer channels. According to aspects of the present disclosure, physical layer control information may be packaged, by a transmitting device, into a MAC-CE as part of a transport block (TB) and transmitted to a receiving device. The receiving device may receive the MAC-CE, and the physical layer control information may be extracted or identified at the MAC layer of the receiving device. The physical control information may then be applied for physical layer procedures.

In some examples, a MAC-CE may include one or more identifiers or indices that may be used to indicate the type of physical layer control information included in the MAC-CE. In one aspect, the MAC-CE is part of a MAC Protocol Data Unit (PDU) that includes a header. The header may indicate a Logical Channel ID (LCID). The LCID may be unique to one or more types of physical layer messages or physical layer control information such that the receiving device can determine how to process the MAC-CE on its arrival. In some cases, there may be one LCID for each physical layer message type. In other cases, there may be one LCID for a plurality of physical layer message types (or types of physical layer control information). In another example, the MAC-CE may include a subheader indicating another ID (for example, in addition to the LCID in the MAC header). The ID may indicate the type of physical layer message or messages that can be carried by the MAC-CE. The MAC-CE may include other fields or identifiers, such as size indicators or time stamps, which may assist the receiving device in processing the MAC-CE and applying the physical layer control information carried therein.

According to one aspect of the present disclosure, a method performed by a first wireless communication device comprises receiving, from a second wireless communication device, physical layer signaling, and transmitting, to the second wireless communication device, a Medium Access Control (MAC) layer control message. In one aspect, the MAC layer control message comprises physical layer control information associated with a first physical layer message type. In another aspect, the physical layer control information is generated based on the physical layer signaling. In another aspect, the MAC layer control message indicates a MAC layer control message type, the MAC layer control message type being associated with the first physical layer message type.

According to another aspect of the present disclosure, a method for wireless communication performed by a first wireless communication device comprises transmitting, to a second wireless communication device, physical layer signaling, and receiving, from the second wireless communication device, a Medium Access Control (MAC) layer control message. In one aspect, the MAC layer control message comprises physical layer control information associated with a first physical layer message type. In another aspect, the physical layer control information is generated based on the physical layer signaling. In another aspect, the MAC layer control message indicates a MAC layer control message type, the MAC layer control message type being associated with the first physical layer message type.

According to another aspect of the present disclosure, a first wireless communication device, comprises one or more memory devices, and one or more processors associated with the one or more memory devices. In some aspects, the first wireless communication device is configured to: receive, from a second wireless communication device, physical layer signaling, and transmit, to the second wireless communication device, a Medium Access Control (MAC) layer control message. In one aspect, the MAC layer control message comprises physical layer control information associated with a first physical layer message type. In another aspect, the physical layer control information is generated based on the physical layer signaling. In another aspect, the MAC layer control message indicates a MAC layer control message type, the MAC layer control message type being associated with the first physical layer message type.

In some other, the first wireless communication device is configured to: transmit, to a second wireless communication device, physical layer signaling, and receive, from the second wireless communication device, a Medium Access Control (MAC) layer control message. In one aspect, the MAC layer control message comprises physical layer control information associated with a first physical layer message type. In another aspect, the physical layer control information is generated based on the physical layer signaling. In another aspect, the MAC layer control message indicates a MAC layer control message type, the MAC layer control message type being associated with the first physical layer message type.

Other aspects and features of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 illustrates a wireless communication network according to one or more aspects of the present disclosure.

FIG. 2 illustrates a diagram of an example disaggregated base station architecture according to one or more aspects of the present disclosure.

FIG. 3 illustrates a signaling diagram for communicating physical layer control information in a Medium Access Control-Control Element (MAC-CE) according to some aspects of the present disclosure.

FIG. 4 illustrates a MAC-CE structure for communicating one or more types of physical layer control information according to some aspects of the present disclosure.

FIG. 5A illustrates a framework for communicating different types of physical layer control information using different types of MAC-CEs according to one or more aspects of the present disclosure.

FIG. 5B illustrates a framework for communicating different types of physical layer control information using a MAC-CE configured for communicating the physical layer control information according to one or more aspects of the present disclosure.

FIG. 5C illustrates a framework for communicating different types of physical layer control information using different types of MAC-CEs according to one or more aspects of the present disclosure.

FIG. 6 illustrates a block diagram of a user equipment (UE) according to one or more aspects of the present disclosure.

FIG. 7 illustrates a block diagram of a network unit according to one or more aspects of the present disclosure.

FIG. 8A illustrates a flow diagram of a wireless communication method according to some aspects of the present disclosure.

FIG. 8B illustrates a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communication networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For instance, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For instance, in various outdoor and macro coverage deployments of less than 3 GHz FDD/TDD implementations, subcarrier spacing may occur with 15 kHz, for instance over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For instance, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/DL that may be flexibly configured on a per-cell basis to dynamically switch between UL and DL to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For instance, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For instance, a method may be implemented as part of a system, device, apparatus, as instructions stored on a computer readable medium for execution on a processor or computer, or a combination of two or more of the above. Furthermore, an aspect may comprise at least one element of a claim.

In wireless communication protocols (e.g., LTE, 5G, 6G, etc.), physical layer control information facilitates efficient data transmission by managing aspects like error correction, channel conditions, and resource allocation. This physical layer control information includes Hybrid Automatic Repeat Request Acknowledgement/Negative Acknowledgement (HARQ ACK/NACK) and Channel State Information (CSI) reports. HARQ ACK/NACK is used for error correction, HARQ feedback indicates successful or unsuccessful receipt of data packets, triggering retransmissions if needed. This feedback enhances reliability and efficiency in data transmission. CSI reports convey channel quality metrics from the receiver to the transmitter, enabling adaptive modulation, coding, and resource scheduling based on current channel conditions. CSI reports optimize throughput and maintain connectivity under varying conditions.

These control messages are carried using specific types of messages and channels. HARQ ACK/NACK information is transmitted using the Physical Uplink Control Channel (PUCCH) or Physical Downlink Control Channel (PDCCH), depending on direction. CSI reports may be transmitted over the PUCCH for periodic reports, while more extensive reports may be sent using the Physical Uplink Shared Channel (PUSCH) if additional bandwidth is required. PDCCH is the main downlink channel for control information, including Downlink Control Information (DCI) for scheduling, grant information, and resource allocations. These channels enable rapid exchange of critical control information to maintain synchronization, ensure data integrity, and dynamically adapt to network conditions, achieving high reliability and throughput in the network.

Transmitting physical layer control information using physical layer messaging would be expected, since it is generally desirable to isolate the different layers of the communication protocol stack from one another. Isolating layers in wireless communication protocols is beneficial flexibility, modularity, and performance by allowing each layer to function independently. Modular design facilitates upgrades and troubleshooting, as changes in one layer have less effect (or no effect) on others. Isolation also supports interoperability across devices from different vendors by adhering to standardized protocols, allowing seamless communication. Additionally, each layer's specialization improves overall efficiency, as tasks are handled by the most suitable layer, like transmission by the physical layer and scheduling by the MAC layer. This separation ensures adaptability to evolving technologies, such as transitions from 4G to 5G, 5G to 6G, etc..

However, higher layer signaling (e.g., MAC layer, L2) may have some advantages for reliability and flexibility compared to physical layer signaling. Physical layer signaling operates at a low level with strict timing requirements, making it more susceptible to errors from noise, interference, and fading. Since physical layer signals aren't as robust as those transmitted through higher layers, they lack built-in error detection and correction mechanisms available in the MAC layer, which makes them more prone to unreliability in challenging channel conditions. The physical layer transmits signals with minimal processing to meet timing constraints. While this helps with speed, it restricts the complexity and flexibility of the information it can carry. The MAC layer, in contrast, can handle more detailed data and sophisticated error correction, enhancing overall reliability. Physical layer messages are typically short and fixed in format due to strict timing requirements. This restricts the amount and type of information that can be conveyed, limiting its adaptability to changing network conditions compared to the more adaptable MAC layer. To meet latency and reliability demands, the physical layer relies on frequent retransmissions (like HARQ), which increases signaling overhead. Higher-layer protocols, with more error resilience, often avoid this extra burden, making them more efficient in some cases.

The present disclosure describes schemes and mechanisms for transmitting physical layer control information as part of a MAC layer control message. In some aspects, one or more MAC layer control message types are defined for carrying one or more types of physical layer control information. For instance, the MAC layer control message may include a MAC-CE, and the MAC layer control message type may be a MAC-CE type. A device with physical layer control information (e.g., HARQ ACK/NACK) to transmit (the “transmitting device”) may generate the physical layer control information at the physical layer (L1), and send it to the MAC layer (L2) to be packaged into a MAC-CE and a MAC PDU. The MAC-CE comprises, or is associated with, a MAC-CE type. The MAC-CE type may be indicated or specified for transmitting physical control layer information. In some aspects, the MAC-CE type is indicated by its Logical Channel ID (LCID). The LCID may indicate one or more types of physical layer messages or control information that are carried by the MAC-CE. In another example, the MAC-CE may include another identifier that explicitly or implicitly indicates the type of physical layer control information it carries.

The MAC layer of the transmitting device may multiplex The MAC-CE with one or more other MAC-CEs (for example, other MAC-CEs controlling physical layer control information). The transmitting device may package the one or more MAC-CEs into a transport block (TB) for transmission to a receiving device. The receiving device receives the TB at the physical layer, and decodes the TB. The decoding results in a MAC-CE being sent to the receiving device's MAC layer for further processing. The receiving device identifies the type of physical layer control information carried in the MAC-CE based on one or more of the identification mechanisms explained above. The receiving device then extracts the physical layer control information from the MAC-CE, and passes that information to the physical layer to be applied.

Embodiments of this disclosure present several advantages. As explained above, MAC-CEs can handle more detailed data and sophisticated error correction, enhancing overall reliability. There may be greater flexibility in the size and content of the physical layer control information that is carried in the MAC-CEs. Further, by specifying and structuring MAC-CE types to specifically handle such control information, isolation between the physical layer and MAC layer may be maintained even while the physical layer control information is being carried via the MAC layer. Thus, the physical layer control mechanisms may operate with greater reliability. This may improve the reliability and consistency of the connection at the physical layer, thereby improving the quality of the connection and the user experience.

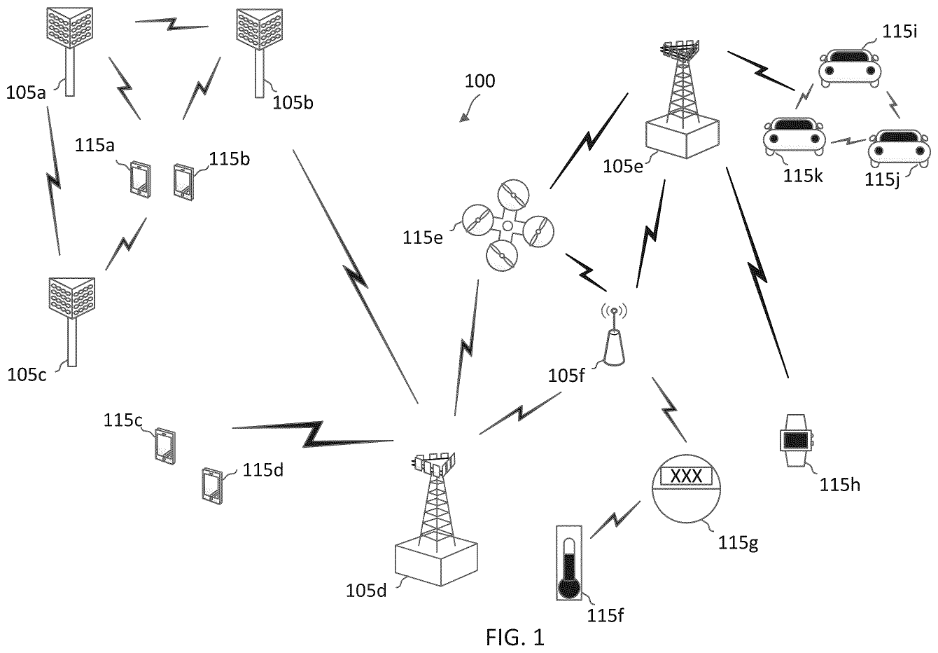

FIG. 1 illustrates a wireless communication network 100 according to one or more aspects of the present disclosure. The network 100 may be a 5G network. The network 100 includes a number of BSs 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a 300 next generation eNB (gNB), an access point, and the like. Each BS 105 may provide communication coverage for a particular geographic area. In 3GPP, the term “cell” can refer to this particular geographic coverage area of a BS 105 or a BS subsystem serving the coverage area, depending on the context in which the term is used.

A BS 105 may provide communication coverage for a macro cell or a small cell, such as a pico cell or a femto cell, or other types of cells or a combination thereof. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

In some aspects, the term “base station” (e.g., the base station 105) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. A “network entity” may also be referred to as a “network unit.” In some aspects, the term “base station” or “network entity” may refer to one device configured to perform one or more functions, such as those described herein in connection with the base stations 105. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are instances of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are instances of various machines configured for communication that access the network 100. The UEs 115i-115k are instances of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the DL, UL, or both, desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an instance of a gNB or an access node controller (ANC)) may interface with the core network through backhaul links (e.g., NG-C, NG-U, etc.) and may perform radio configuration and scheduling for communication with the UEs 115. In various cases, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such asV2V, V2X, C-V2X communications between a UE 115i, 115j, or 115k and other UEs 115, vehicle-to-infrastructure (V2I) communications between a UE 115i, 115j, or 115k and a BS 105, or a combination thereof.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing, the duration of TTIs, or both, may be scalable.

In some aspects, the BSs 105 can assign or schedule transmission resources (e.g., in the form of time-frequency resource blocks (RB)) for DL and UL transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for instance, about 10. Each slot may be further divided into mini-slots. In a FDD mode, simultaneous UL and DL transmissions may occur in different frequency bands. For instance, each subframe includes a UL subframe in a UL frequency band and a DL subframe in a DL frequency band. In a TDD mode, UL and DL transmissions occur at different time periods using the same frequency band. For instance, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For instance, each DL or UL subframe may have pre-defined regions for transmissions of reference signals, control information, and data. Reference signals are predetermined signals that facilitate the communications between the BSs 105 and the UEs 115. For instance, a reference signal can have a particular pilot pattern or structure, where pilot tones may span across an operational BW or frequency band, each positioned at a pre-defined time and a pre-defined frequency. For instance, a BS 105 may transmit cell specific reference signals (CRSs), channel state information -reference signals (CSI-RSs), or both, to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data, operational data, or a combination thereof. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for DL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, the MIB, or a combination thereof, in the form of synchronization signal block (SSBs) and may broadcast the RMSI, the OSI, or a combination thereof, over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI, OSI, or both. After decoding the MIB, the UE 115 may receive RMSI, OSI, or both. The RMSI and OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI, the OSI, or a combination thereof, the UE 115 can perform a random access procedure to establish a connection with the BS 105. In some instances, the random access procedure may be a four-step random access procedure. For instance, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), a backoff indicator, or a combination thereof. Upon receiving the random access response, the UE 115 may transmit a connection request to the BS 105 and the BS 105 may respond with a connection response. The connection response may indicate a contention resolution. In some instances, the random access preamble, the RAR, the connection request, and the connection response can be referred to as message 1(MSG 1 ), message 2(MSG 2 ), message 3(MSG 3 ), and message 4(MSG 4 ), respectively. In some instances, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For instance, the BS 105 may schedule the UE 115 for UL and DL communications. The BS 105 may transmit UL and DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH or PUCCH according to a UL scheduling grant. The connection may be referred to as an RRC connection. When the UE 115 is actively exchanging data with the BS 105, the UE 115 is in an RRC connected state.

In some aspects, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), a packet data network gateway (PGW), or a combination thereof, to complete the network attachment procedure. For instance, the BS 105 may coordinate with the network entities in the 5GC to identify the UE, authenticate the UE, or authorize the UE for sending or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for instance, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). After receiving the DL data packet, the UE 115 may transmit a feedback message for the DL data packet to the BS 105. In some instances, the UE 115 may transmit the feedback on an acknowledgment resource. The feedback may be an acknowledgement (ACK) indicating that reception of the DL data packet by the UE 115 is successful (e.g., received the DL data without error) or may be a negative-acknowledgement (NACK) indicating that reception of the DL data packet by the UE 115 is unsuccessful (e.g., including an error or failing an error correction). In some aspects, if the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For instance, the BWP pair may include one BWP for UL communications and one BWP for DL communications.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

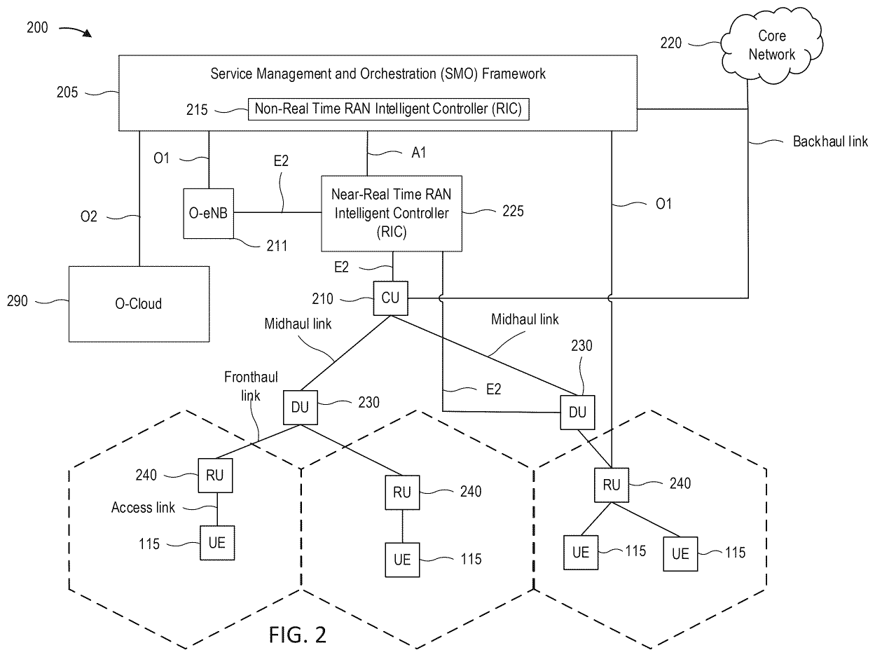

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUs 210, the DUs 230, the RUs 240, as well as the Near-RT RICs 225, the Non-RT RICs 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

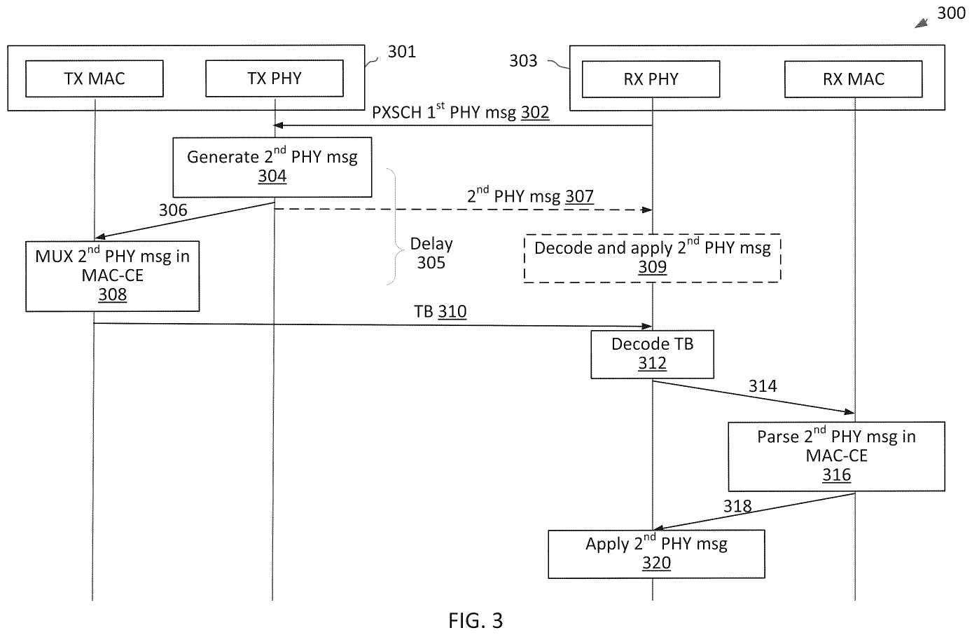

FIG. 3 illustrates a signaling diagram for communicating one or more types of physical layer control information according to aspects of the present disclosure. More specifically, the signaling diagram illustrates a scheme 300 for transmitting the physical layer control information in a MAC layer control message. In an exemplary aspect, the MAC layer control message includes a MAC-CE. Aspects of the physical layer control information communication scheme 300 may be utilized in the context of the wireless communication network 100 including a transmitting wireless communication device 301 and a receiving wireless communication device 303. Each of the devices 301 and 303 includes a MAC layer module (i.e. TX MAC, RX MAC) and a physical layer module (i.e., TX PHY, RX PHY). In some aspects, the transmitting device 301 may be, for instance, a UE in a cellular wireless network. The receiving device 303 may include a BS in the cellular wireless network. In other aspects, the transmitting device 301 may include a BS and the receiving device 303 may be a UE. In other aspects, both the transmitting device 301 and the receiving device 303 may be UEs communicating via sidelink channels.

It will be understood that both the “transmitting” and “receiving” devices 301, 303 can both transmit and receive communications. The “transmitting” device is so named because it transmits the physical layer control information in a MAC layer control message, as further explained below.

At action 302, the receiving device 303 transmits, and the transmitting device receives, a first physical layer message. The physical layer message 302 is transmitted on a physical layer channel, such as a PDSCH, a PDCCH, a PUSCH, a PUCCH, a PSSCH, a PSCCH, or any other suitable type of physical channel. The physical layer message may include downlink data, uplink data, a reference signal, or any other suitable type of information. The physical layer message may include a CSI reference signal, for instance.

At action 304, the transmitting device 301 generates, using the physical layer module (TX PHY), a second physical layer message. In some aspects, the second physical layer message comprises physical layer control information. The physical layer control information may include, for instance, HARQ ACK/NACK information (e.g., one or more HARQ ACK/NACK bits, a HARQ ACK/NACK codebook, etc.), a CSI report, or any other similar physical layer control information, or a combination thereof. Generating the physical layer control information may be based on the first physical layer message received at action 302. For instance, the first physical layer message may include downlink data received on a PDSCH, and the second physical layer message may include HARQ ACK/NACK information corresponding to the reception and decoding of the PDSCH. In another example, the first physical layer message may comprise a CSI reference signal, and the second physical layer message may comprise a CSI report based on the CSI reference signal.

At action 306, the physical layer module (TX PHY) of the transmitting device 301 sends, provides, or otherwise makes available, the second physical layer message to the MAC layer (TX MAC). It will be understood that action 306 may be performed within the same processing circuitry (e.g., modem), and that action 306 may not involve a transmission of the second physical layer message to any other hardware module of the transmitting device 301. In other words, action 306 may be a conceptual step in which the second physical layer message (including the physical layer control information) is processed by the MAC module (TX MAC). Thus, action 306 may comprise or represent software steps realized by any suitable implementation.

At action 308, the MAC module (TX MAC) packages the second physical layer message into a MAC layer control message. In one aspect, the MAC layer control message includes a MAC-CE. Thus, although embodiments of the present disclosure may describe using MAC-CEs to transmit physical layer control information, it will be understood that the embodiments described herein, including the methods, devices, systems, and mechanisms of the present disclosure, contemplate packaging the physical layer control information in any suitable MAC layer control message. In some aspects, action 308 includes packaging the second physical layer message into a MAC-CE, which is then packaged into a MAC PDU envelope. The MAC PDU envelope may include the MAC-CE, and one or more other MAC-CEs. The one or more other MAC-CEs may also carry physical layer control information.

The MAC-CE in which the second physical layer message is packaged is associated with a MAC-CE type. The MAC-CE type may be represented by, or otherwise associated with, the LCID of the MAC-CE. The LCID may be associated with one or more types of physical layer message types (e.g., msg 1, msg 2, msg 3, etc.). In another aspects, the LCID may be associated with one or more types of physical layer control information. In another aspect, the LCID may be associated with a priority, where the priority is associated with one or more physical layer message types. The MAC-CE may comprise, or be associated with, other information or indications.

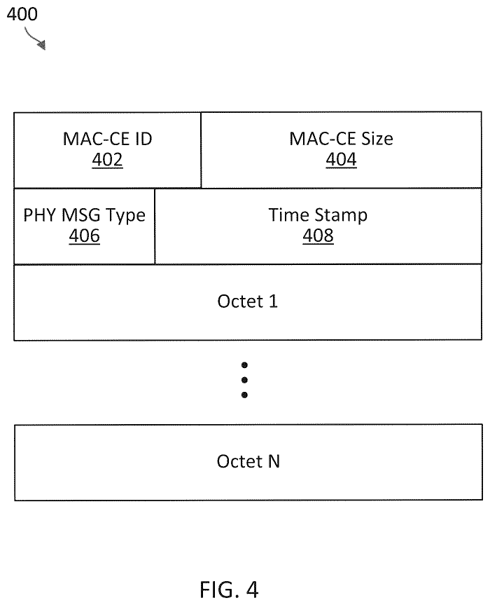

In that regard, FIG. 4 illustrates an exemplary structure of a MAC-CE for carrying physical layer control information. The MAC-CE 400 is shown as having a MAC-CE ID 402. In some aspects, the MAC-CE ID may comprise a LCID. The MAC-CE further comprises a MAC-CE size indicator 404, a physical message type indicator 406, a time stamp 408, and N octets of MAC-CE data. The N octets may carry the physical layer control information of the second physical layer control message of the scheme 300.

The MAC-CE size indicator 404 may indicate, for example, a number (N) of octets in the MAC-CE 400, a number of unused bits in the final octet (Octet N), or both. In some aspects, the number of unused bits in the last octet may be derived based on an RRC configuration or some other information. The indication of the number of unused bits in the last octet may be beneficial in cases where size of the physical layer message is not byte-aligned. In these instances, the MAC layer module of the receiving device would strip off any padding bits before sending back to the physical layer module.

In other aspects, the MAC-CE size indicator may indicate a total number of bits of the MAC-CE 400. In another aspect, the MAC-CE size indicator 404 may indicate a number of used (rather than unused) bits in the final octet of the MAC-CE 400. In some aspects, the MAC-CE size indicator 404 is an explicit indication of the MAC-CE size. However, it will be understood that the MAC-CE 400 may indicate its size implicitly. For instance, the MAC-CE ID 402 itself may implicitly indicate the size of the MAC-CE 400. In another aspect, the physical message type indicator 406 may implicitly indicate the size of the MAC-CE 400. In some aspects, there may be no explicit size indicator for the MAC-CE.

Whether there is an explicit MAC-CE indicator 404 may depend on the type of MAC-CE, or the type of physical messages carried by, or supported by, the MAC-CE type. For instance, one type of MAC-CE configured to carry a first type of physical layer control information (or a first type of physical layer message) may support size flexibility. Some physical layer message types may have dynamically changing sizes. For example, a CSI report size may depend at least in part on RI. In another example, a HARQ ACK codebook size may change based on scheduling decisions. In this case, it may be beneficial to explicitly indicate the size of the MAC-CE via the indicator 404. In another example, there may be less benefit or desire for size flexibility for a MAC-CE supporting a second type of physical layer message. In such a case, the MAC-CE may include no MAC-CE size indicator 404. In some embodiments, the size of the MAC-CE may be derived by the receiving device based on an RRC configuration. For instance, the LCID of the MAC-CE may implicitly indicate the size of the MAC-CE. In another example, the physical layer message type indicator 404 may implicitly indicate the size of the MAC-CE.

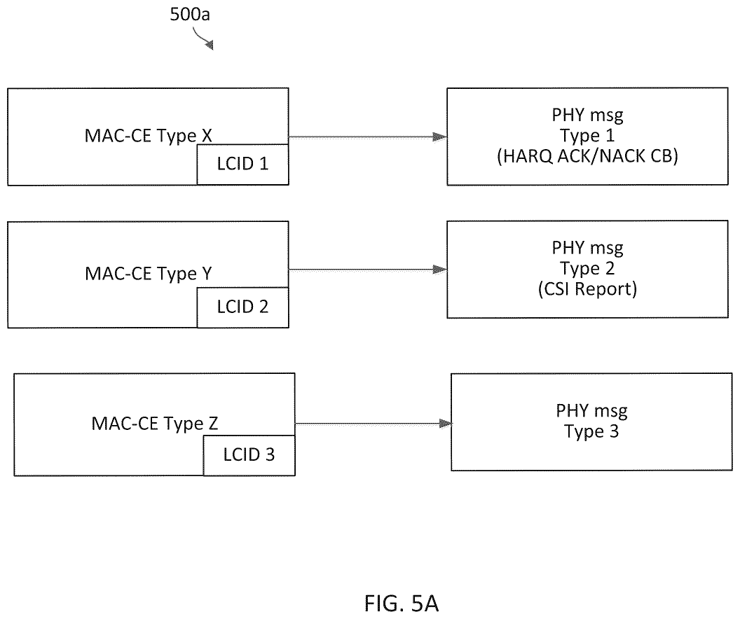

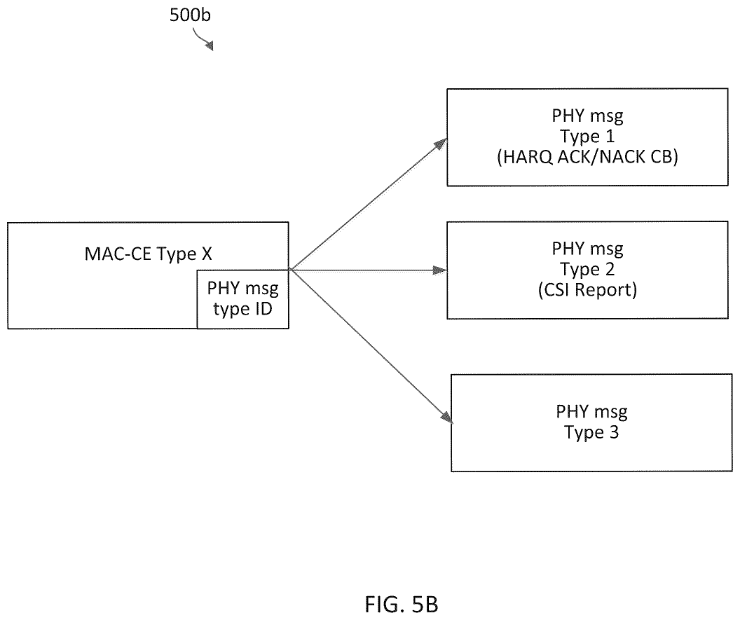

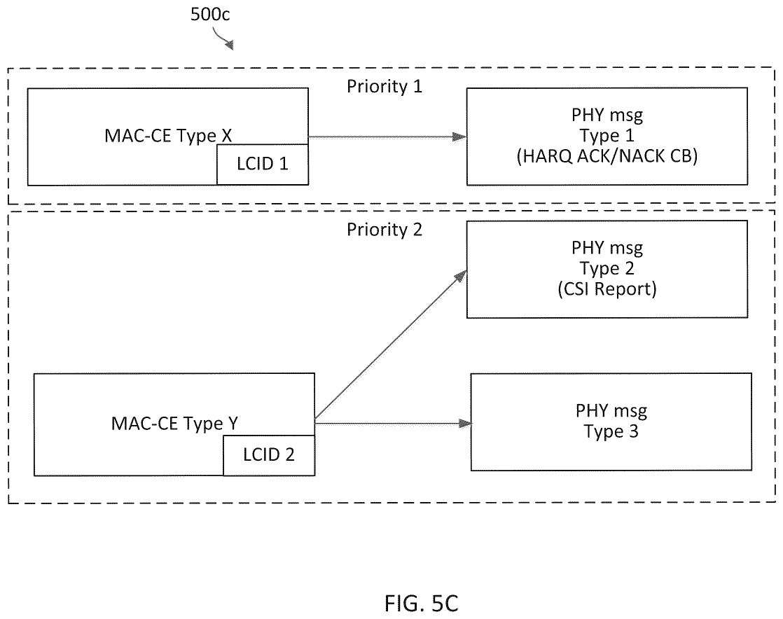

The MAC-CE 400 shown in FIG. 4 further includes a physical message type indicator 406. In some aspects, the physical message type indicator may include an index or other value associated with one or more types of physical layer messages, or one or more types of physical layer control information. In another example, the physical layer message type indicator 406 may indicate a priority, where the priority is associated with one or more types of physical layer messages. In this regard, FIGS. 5A-5B illustrate various examples of MAC-CE types and their corresponding indications. In some aspects, the MAC-CE types X, Y, Z, are new MAC-CE types for transmitting physical layer control information only. For instance, new, unused, or reserved MAC-CE LCID values may be designated for the physical layer message types.

FIG. 5A illustrates a first scheme 500a for associating MAC-CE types X, Y, and Z with physical layer message types 1, 2, and 3. In this example, each MAC-CE is specified for, or associated with, one type of physical layer message. In other words, in the scheme 500a, there is a one-to-one correspondence between the MAC-CE type and the physical layer message type. The MAC-CE type is indicated by the LCID. However, it will be understood that other indicators or indices may be used to explicitly or implicitly indicate the MAC-CE type (i.e., X, Y, or Z). In the example of FIG. 5A, MAC-CE type X is indicated by LCID 1. This MAC-CE type X corresponds to physical layer message type 1. As illustrated, physical layer message type 1 corresponds to HARQ ACK/NACK information, such as a HARQ ACK/NACK codebook. However, it will be understood that physical layer message type 1 may correspond to any suitable type of physical layer control information, including CSI reports. Similarly, MAC-CE type Y is indicated by LCID 1. This MAC-CE type Y corresponds to physical layer message type 2, which is illustrated as a CSI report. Again, any suitable type of physical layer message or control information may correspond to MAC-CE type Y. MAC-CE type Z corresponds to physical layer message type 3.

In some aspects, different MAC-CE types (X, Y, or Z) may include different fields or information. For instance, one or more MAC-CE types may carry each of the fields illustrated in FIG. 4, while other MAC-CE types may include more or less information than what is shown in FIG. 4. In the example of FIG. 5A, the MAC-CE structure may not include the physical layer message type field 406. This is because the physical layer message type may already be determined by the MAC-CE ID 402. In the other examples of FIGS. 5B and 5C, for instance, the MAC-CE ID 402 may be used for more than one type of physical layer message. In those cases, it may be desirable to explicitly indicate the type of physical layer message (or physical layer control information) carried in the MAC-CE.

FIG. 5B illustrates a second scheme 500b for associating and indicating a MAC-CE type X with one of a plurality of physical layer message types (1, 2, and 3). In this example, the MAC-CE type X is a MAC-CE structure or format for carrying multiple types of physical layer messages. Because the MAC-CE can carry multiple different types of physical layer messages, the MAC-CE includes a physical message type ID. In some aspects, the physical message type ID may include an index or value associated with a physical message type. In some aspects, the physical message type ID may be associated with one type of physical layer control information, or multiple types of physical layer control information. Based on the physical message type indicator, the receiving device may determine what type of physical control information is contained in the MAC-CE.

FIG. 5C illustrates a third scheme 500c for associating and indicating a MAC-CE type. In the embodiment of FIG. 5C, multiple MAC-CE types are provided, with each MAC-CE type associated with a group of one or more physical layer message types. In the illustrated embodiment, the grouping is based on a priority value. MAC-CE type X with LCID 1 is associated with a priority value of 1, and MAC-CE type Y with LCID 2 is associated with a priority value of 2. The MAC-CE type X corresponds only to physical layer message type 1 (e.g., HARQ ACK/NACK CB). The MAC-CE type Y corresponds to physical layer message types 2 and 3. However, it will be understood that the grouping is not limited to the embodiment of FIG. 5C, and that each MAC-CE type may be associated with fewer or more physical message types than what is shown in FIG. 5C.

In some aspects, the grouping of physical layer message types with MAC-CE types may be based on a parameter different from priority. For instance, the grouping of physical layer message types with the MAC-CE message type may be based on the size of the physical layer message, the Quality of Service requirements, or any other suitable parameter.

Returning to FIG. 4, the MAC-CE may include a time stamp indicator 408. In some aspects, the time stamp indicator may indicate one or more of a generation time of the physical layer message carried in the MAC-CE or an expiration time of the physical layer message. The time stamp may assist the receiving device in processing the physical layer control information. For instance, the receiving device may determine not to decode, process, or apply the physical layer control information if the physical layer control information is stale or expired. It will be appreciated that the process of packaging the physical layer control information into MAC-CEs and MAC PDUs and multiplexing for transmission in a PDU may result in some delays in the transmission, reception, and extraction of the physical layer control information compared to simply transmitting the physical layer control information in physical layer messages. Referring briefly to FIG. 3, the delay 305 illustrates the time delay associated with packaging the second physical layer message into the MAC-CE. In some cases, the delay may result in the physical layer control information being stale. In this case, it may be preferrable not to apply or process the physical layer control information.

In another aspect, the time stamp may used by the transmitting device to verify whether the MAC-CE should be transmitted, or whether it is stale. In the case where the transmitting device is determined to be stale, the transmitting device may wait for replacement physical control layer information before transmitting the MAC-CE. Alternatively, the transmitting device may simply determine not to transmit that MAC-CE.

Referring again to FIG. 4, it will be understood that the various indicators (e.g., 402, 404, 406, 408) of the MAC-CE described above may be carried or indicated in a variety of ways. For instance, the MAC-CE may include a subheader including one or more of the MAC-CE ID 402, the MAC-CE size indicator 404, the physical layer message type indicator 406, the time stamp indicator 408, or a combination thereof. In another aspect, one or more of those fields may be included in a MAC PDU header. In other aspects, one or more of those indicators may be carried in a field of the MAC-CE, such as within one of the Octets 1-N.

Returning to FIG. 3, at action 310, the transmitting device 301 transmits, to the receiving device 303, a TB including the MAC-CE carrying the second physical layer message. The TB may be carried in a physical layer channel, such as a PDSCH, a PUSCH, a PSSCH, or any other suitable physical layer channel. In some aspects, the transmitting device comprises a UE, and the receiving device comprises a network unit (e.g., BS 105, RU). In this example, the UE may transmit the TB in a PUSCH. The TB includes the MAC-CE, which carries HARQ ACK/NACK information related to the first physical layer message transmitted at 302. For instance, the HARQ ACK/NACK information may indicate that downlink data transmitted on a PDSCH was received and decoded. In another example, the transmitting device 301 comprises a network unit (e.g., BS 105 or RU), and the receiving device 303 comprises a UE. In another example, both the transmitting device 301 and the receiving device 303 comprise UEs.

At action 312, the receiving device 303 decodes and processes the TB to extract the MAC-CE. The TB may include one or more MAC PDUs, where each MAC PDU carries one or more MAC-CEs. In some instances, the MAC-CEs carried in the TB may comprise a combination of physical layer message-type MAC-CEs, and legacy, conventional MAC-CEs carrying L2 information. In other instances, the MAC-CEs carried in the TB may all be physical layer message-type MAC-CEs carrying physical layer control information. At the physical layer, the decoding process of action 312 may include demodulating and processing the received physical layer signal to obtained the encoded TB data. The encoded TB data is then decoded with error correction to correct any errors in the received TB data bits. The physical layer module may then perform a Cyclic Redundancy Check (CRC) on the error-corrected data. If the CRC fails, the receiving device responds with a NACK, triggering a HARQ retransmission of the TB. If the CRC passes, the TB data is passed to the MAC layer.

The TB may include one or more MAC Service Data Units (SDUs), one or more MAC PDUs, or a combination thereof. The MAC PDU's may include one or more MAC-CEs, including the MAC-CE carrying the second physical layer message. The MAC layer module (RX MAC) parses the MAC header of the TB, including any LCIDs indicated therein. Based on the LCID values, the MAC layer identifies each MAC-CE in the transport block, including the type of MAC-CE (e.g., MAC-CE type X, Y, Z, etc.).

At action 314, the physical layer module (RX PHY) of the receiving device 303 sends, provides, or otherwise makes available, the MAC PDU, or MAC-CE carried in the MAC PDU, to the MAC layer module (RX MAC). As similarly explained above with respect to action 306, action 314 may be performed within the same processing circuitry (e.g., modem). Thus, action 314 may not involve a transmission of the MAC-CE to any other hardware module of the receiving device 303. In other words, action 314 may be a conceptual step in which the MAC-CE is processed by the physical layer module (TX MAC). Thus, action 314 may comprise or represent software steps realized by any suitable implementation. In one example, action 314 includes a memory management operation in which the MAC-CE is written onto a memory buffer for interpretation by the MAC layer software module.

At action 316, the MAC layer (RX MAC) of the receiving device parses the second physical layer message from the MAC-CE. In some aspects action 316 comprises determining, based on one or more indicators or fields in the MAC-CE (or MAC PDU), whether to send, provide, or otherwise make available, the physical layer control information to the physical layer module (RX PHY) of the receiving device. For instance, as explained above with respect to FIGS. 4 and 5A-5C, the receiving device 303 may use one or more of the MAC LCID, a physical layer message type indicator, a priority level indicator, a MAC-CE size indicator, or any other suitable field or indicator of the MAC-CE, whether the MAC-CE includes physical layer control information, and what type of physical layer control information is included.

At action 318, the MAC layer module (RX MAC) of the receiving device 303 sends, provides, or otherwise makes available, the extracted physical layer message to the physical layer module (RX PHY). In some aspects, action 318 may be conditional on the time stamp indicator of the MAC-CE. For instance, if the MAC layer module determines that the second physical layer message is stale, the MAC layer module may determine not to send the second physical layer message to the physical layer module. For that matter, it will be understood that one or more aspects of previous action 316 may similarly be dependent on whether the second physical layer message is stale. In some aspects, this involves comparing an expiration time stamp indicated in the MAC-CE (or MAC PDU) to a configured threshold or other time value to determine that the second physical layer message is stale. In another example, the time stamp may indicate a time of generation of the physical layer control information. The receiving device may compare the time of generation to another threshold or time value to determine whether the second physical layer message is stale.

At action 320, the physical layer module (RX PHY) of the receiving device 303 processes and applies the physical layer control information (e.g., HARQ ACK/NACK, CSI report, etc.) for further physical layer communications. In some aspects, action 320 may process the physical layer control information in the second physical layer message just as it would have done if the second physical layer message had been receiving using conventional legacy physical control information messaging procedures. In one example, action 320 comprises using a CSI report included in the MAC-CE to adjust one or more parameters related to modulation and coding schemes (MCS) or beamforming for later downlink transmissions. In another example, the physical layer control information indicates a NACK for the physical layer message communicated at action 302. In this example, action 320 comprises, or results in, the MAC layer module scheduling a retransmission of the first physical layer message communicated at action 302. The physical layer module then performs the retransmission to the transmitting device 301 over a physical layer channel (e.g., PDSCH, PUSCH). The transmitting device 301 may use soft combining of the retransmitted physical layer message to improve decoding and increase the chance of a successful decoding.

FIG. 3 illustrates an optional additional action 307, which may be performed in connection with action 309. The dashed line for action 307, and the dashed box for action 309, represent the optional nature of these actions. In this regard, although the encoding and processing of the second physical layer message as part of a TB may result in more reliable communication of that information, the transmitting device 301 may transmit the second physical layer message both using conventional physical layer signaling mechanisms, and using the MAC-CE mechanisms described above. In action 307, the physical layer module (TX PHY) transmits the second physical layer message to the receiving device 303 as a physical layer message. Because the physical layer message is not packaged into a MAC-CE, there is significantly less delay, but the message may be more susceptible to decoding errors. At action 309, the physical layer module (RX PHY) of the receiving device 303 attempts to decode the second physical layer message. If the decoding is successful, the receiving device 303 applies the physical layer control information included therein. If it is not successful, the receiving device has another chance to decode and apply the second physical layer message in steps 312-320.

In some aspects, the receiving device 303 may be configured to apply the physical layer control information carried in the second physical layer message in the MAC-CE (actions 316-320) only if that physical layer control information was not decoded and applied at action 309.

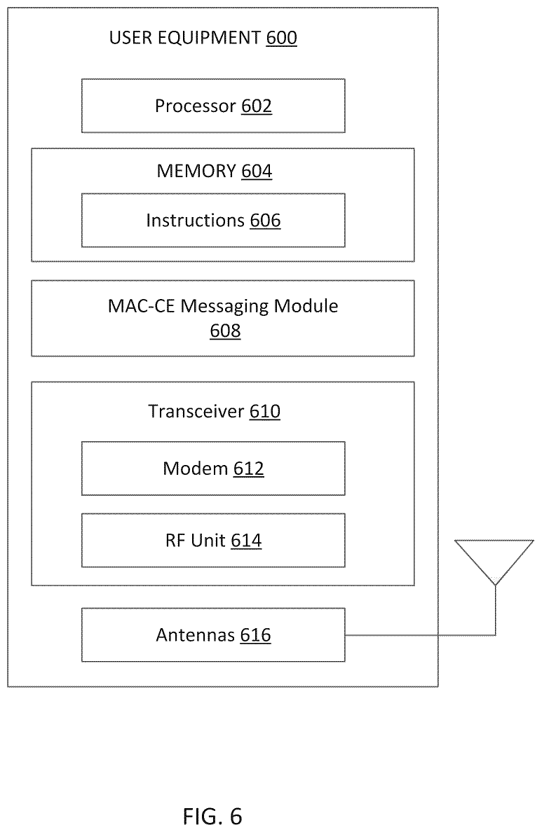

FIG. 6 is a block diagram of a UE 600 according to one or more aspects of the present disclosure. The UE 600 may be, for instance, a UE 115 as discussed in FIGS. 1 and 2. The UE 600 may be the transmitting device 301 or the receiving device 303 of FIG. 3. As shown, the UE 600 may include a processor 602, a memory 604, a MAC-CE messaging module 608, a transceiver 610 including a modem subsystem 612 and an RF unit 614, and one or more antennas 616. These elements may be coupled with one another. The term “coupled” may refer to directly or indirectly coupled or connected to one or more intervening elements. For instance, these elements may be in direct or indirect communication with each other, for instance via one or more buses.

The processor 602 may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, solid state memory device, hard disk drives, other forms of volatile and non-volatile memory, or a combination of different types of memory. In an aspect, the memory 604 includes a non-transitory computer-readable medium. The memory 604 may store, or have recorded thereon, instructions 606. The instructions 606 may include instructions that, when executed by the processor 602, cause the processor 602 to perform the operations described herein with reference to a UE 115 in connection with aspects of the present disclosure, for instance, aspects of FIGS. 3-5C, 8A and 8B. Instructions 606 may also be referred to as program code. The program code may be for causing a wireless communication device to perform these operations, for instance by causing one or more processors (such as processor 602) to control or command the UE 600 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The MAC-CE messaging module 608 may be implemented via hardware, software, or combinations thereof. For instance, the MAC-CE messaging module 608 may be implemented as a processor, circuit, or as instructions 606 stored in the memory 604 and executed by the processor 602. In some aspects, the MAC-CE messaging module 608 can be integrated within the modem subsystem 612. For instance, the MAC-CE messaging module 608 can be implemented by a combination of software components (e.g., executed by a DSP or a general processor) and hardware components (e.g., logic gates and circuitry) within the modem subsystem 612. The MAC-CE messaging module 608 may communicate with one or more components of the UE 600 to implement various aspects of the present disclosure, for instance, aspects of FIGS. 3-5C, 8A, and 8B.

In some aspects, the MAC-CE messaging module 608 may be configured, along with other components of the UE 600, to communicate a MAC-CE comprising physical layer control information. For instance, the MAC-CE messaging module 608 may be configured to package a physical layer message comprising the physical layer control information into a MAC-CE. The physical layer control information may comprise one or more of a HARQ-ACK codebook, a CSI report, or any other suitable type of physical layer control information. The MAC-CE messaging module 608 may associate the MAC-CE with a physical layer message type. For instance, the MAC-CE messaging module may be configured to provide, generate, or apply one or more indicators (e.g., LCID, physical layer message type index, priority value) to the MAC-CE or a MAC PDU that indicates one or more physical layer message types. In another aspect, the MAC-CE messaging module 608 may be configured to generate and apply a size indicator for the MAC-CE. The size indicator may indicate a number of octets in the MAC-CE, a number of unused bits in a last octet of the MAC-CE, a number of total bits in the MAC-CE, or a combination thereof.

In some aspects, the MAC-CE messaging module 608 may be configured to generate and apply a time stamp for the physical layer control information carried in the MAC-CE. For instance, the MAC-CE may comprise a subheader having a time stamp field. In some aspects, the time stamp indicates a generation time of the physical layer control information. In another aspect, the time stamp indicates an expiration time for the physical layer control information. The expiration time may indicate a time at which the physical layer control information is considered “stale,” and should be ignored by the receiving device.

In some aspects, the MAC-CE messaging module 608 is configured to receive, decode, and parse the physical layer control information from the MAC-CE. In another aspect, the MAC-CE messaging module 608 is configured to apply the physical layer control information for future physical layer communications. For instance, the MAC-CE messaging module may initiate or trigger a HARQ retransmission of physical layer messages or transmissions based on receiving a NACK carried in the MAC-CE. In another example, the MAC-CE messaging module 608 adjusts a channel parameter based on a CSI report carried in the MAC-CE.

As shown, the transceiver 610 may include the modem subsystem 612 and the RF unit 614. The transceiver 610 can be configured to communicate bi-directionally with other devices, such as the BSs 105 or network units. The modem subsystem 612 may be configured to modulate and encode the data from the memory 604 or the MAC-CE messaging module 608 according to a MCS, e.g., a LDPC coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., communication signals, data signals, control signals, physical layer messages, physical layer control information transport blocks, MAC PDUs, MAC SDUs, MAC-CEs, etc.) from the modem subsystem 612 (on outbound transmissions). The RF unit 614 may be further configured to perform analog beamforming in conjunction with the digital beamforming. Although shown as integrated together in transceiver 610, the modem subsystem 612 and the RF unit 614 may be separate devices that are coupled together at the UE 600 to enable the UE 600 to communicate with other devices.

The RF unit 614 may provide the modulated and processed data, e.g., data packets (or, more generally, data messages that may contain one or more data packets and other information), to the antennas 616 for transmission to one or more other devices. The antennas 616 may further receive data messages transmitted from other devices. The antennas 616 may provide the received data messages for processing and demodulation at the transceiver 610. The transceiver 610 may provide the demodulated and decoded data (e.g., communication signals, data signals, control signals, communication signals, data signals, control signals, physical layer messages, physical layer control information transport blocks, MAC PDUs, MAC SDUs, MAC-CEs, etc.) to the MAC-CE messaging module 608 for processing. The antennas 616 may include multiple antennas of similar or different designs in order to sustain multiple transmission links.

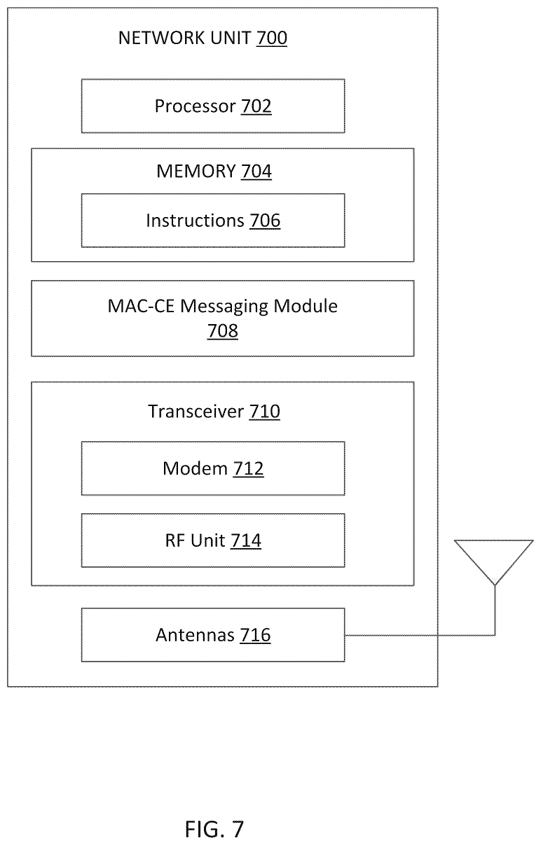

FIG. 7 is a block diagram of a network unit 700 according to one or more aspects of the present disclosure. The network unit 700 may be a BS 105, CU 210, DU 230, an RU 240, or a combination thereof, as discussed in FIGS. 1-2. The network unit 700 may be the transmitting device 301 or the receiving device 303 of FIG. 3. Accordingly, the network unit 700 may include a BS. The BS may be an aggregated BS or a disaggregated BS, as described above. As shown, the network unit 700 may include a processor 702, a memory 704, a MAC-CE messaging module 708, a transceiver 710 including a modem subsystem 712 and a radio frequency (RF) unit 714, and one or more antennas 716. These elements may be coupled with one another. The term “coupled” may refer to directly or indirectly coupled or connected to one or more intervening elements. For instance, these elements may be in direct or indirect communication with each other, for instance via one or more buses.

The processor 702 may have various features as a specific-type processor. For instance, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, a solid state memory device, one or more hard disk drives, memristor-based arrays, other forms of volatile and non-volatile memory, or a combination of different types of memory. In some aspects, the memory 704 may include a non-transitory computer-readable medium. The memory 704 may store instructions 706. The instructions 706 may include instructions that, when executed by the processor 702, cause the network unit 700 to perform operations described herein, for instance, aspects of FIGS. 3-5C, 8A, and 8B. Instructions 706 may also be referred to as program code. The program code may be for causing a wireless communication device to perform these operations, for instance by causing one or more processors (such as processor 702) to control or command the network unit 700 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The MAC-CE messaging module 708 may be implemented via hardware, software, or combinations thereof. For instance, the MAC-CE messaging module 708 may be implemented as a processor, circuit, or instructions 706 stored in the memory 704 and executed by the processor 702. In some instances, the MAC-CE messaging module 708 can be integrated within the modem subsystem 712. For instance, the MAC-CE messaging module 708 can be implemented by a combination of software components (e.g., executed by a DSP or a general processor) and hardware components (e.g., logic gates and circuitry) within the modem subsystem 712. The MAC-CE messaging module 708 may communicate with one or more components of the network unit 700 to implement various aspects of the present disclosure, for instance, aspects of FIGS. 3-5C, 8A, and 8B.

In some aspects, the MAC-CE messaging module 708 may be configured, along with other components of the network unit 700, to communicate a MAC-CE comprising physical layer control information. For instance, the MAC-CE messaging module 708 may be configured to package a physical layer message comprising the physical layer control information into a MAC-CE. The physical layer control information may comprise one or more of a HARQ-ACK codebook, a CSI report, or any other suitable type of physical layer control information. The MAC-CE messaging module 708 may associate the MAC-CE with a physical layer message type. For instance, the MAC-CE messaging module may be configured to provide, generate, or apply one or more indicators (e.g., LCID, physical layer message type index, priority value) to the MAC-CE or a MAC PDU that indicates one or more physical layer message types. In another aspect, the MAC-CE messaging module 708 may be configured to generate and apply a size indicator for the MAC-CE. The size indicator may indicate a number of octets in the MAC-CE, a number of unused bits in a last octet of the MAC-CE, a number of total bits in the MAC-CE, or a combination thereof.

In some aspects, the MAC-CE messaging module 708 may be configured to generate and apply a time stamp for the physical layer control information carried in the MAC-CE. For instance, the MAC-CE may comprise a subheader having a time stamp field. In some aspects, the time stamp indicates a generation time of the physical layer control information. In another aspect, the time stamp indicates an expiration time for the physical layer control information. The expiration time may indicate a time at which the physical layer control information is considered “stale,” and should be ignored by the receiving device.

In some aspects, the MAC-CE messaging module 708 is configured to receive, decode, and parse the physical layer control information from the MAC-CE. In another aspect, the MAC-CE messaging module 708 is configured to apply the physical layer control information for future physical layer communications. For instance, the MAC-CE messaging module may initiate or trigger a HARQ retransmission of physical layer messages or transmissions based on receiving a NACK carried in the MAC-CE. In another example, the MAC-CE messaging module 708 adjusts a channel parameter based on a CSI report carried in the MAC-CE.

As shown, the transceiver 710 may include the modem subsystem 712 and the RF unit 714. The transceiver 710 can be configured to communicate bi-directionally with other devices, such as the UE 105, UE 600, or another network unit. The modem subsystem 712 may be configured to modulate and encode data according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., communication signals, data signals, control signals, physical layer messages, physical layer control information transport blocks, MAC PDUs, MAC SDUs, MAC-CEs, etc.) from the modem subsystem 712 (on outbound transmissions). The RF unit 714 may be further configured to perform analog beamforming in conjunction with the digital beamforming. Although shown as integrated together in transceiver 710, the modem subsystem 712, or the RF unit 714 may be separate devices that are coupled together at the network unit 700 to enable the network unit 700 to communicate with other devices.

The RF unit 714 may provide the modulated and processed data, e.g., data packets (or, more generally, data messages that may contain one or more data packets and other information), to the antennas 716 for transmission to one or more other devices. The antennas 716 may further receive data messages transmitted from other devices and provide the received data messages for processing and demodulation at the transceiver 710. The transceiver 710 may provide the demodulated and decoded data (e.g., communication signals, data signals, control signals, physical layer messages, physical layer control information transport blocks, MAC PDUs, MAC SDUs, MAC-CEs, etc.) to the MAC-CE messaging module 708 for processing. The antennas 716 may include multiple antennas of similar or different designs in order to sustain multiple transmission links.

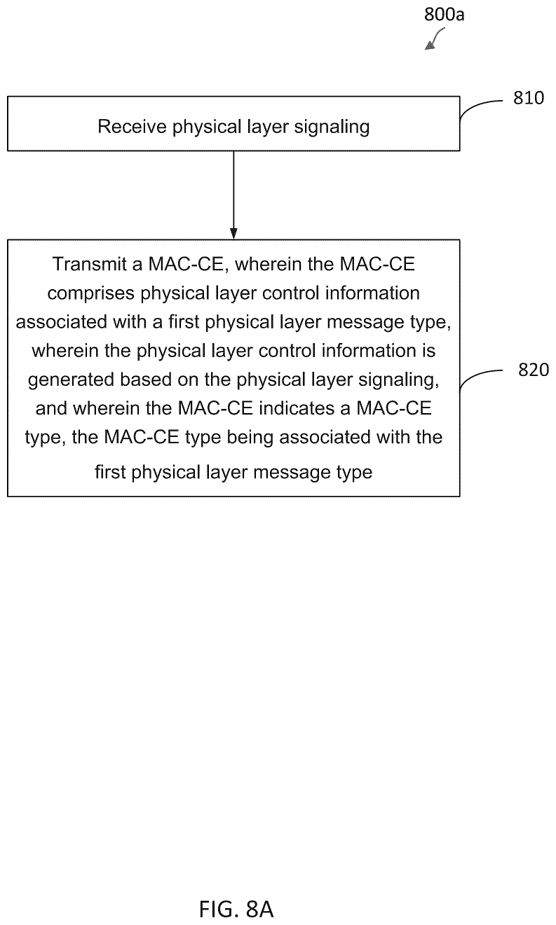

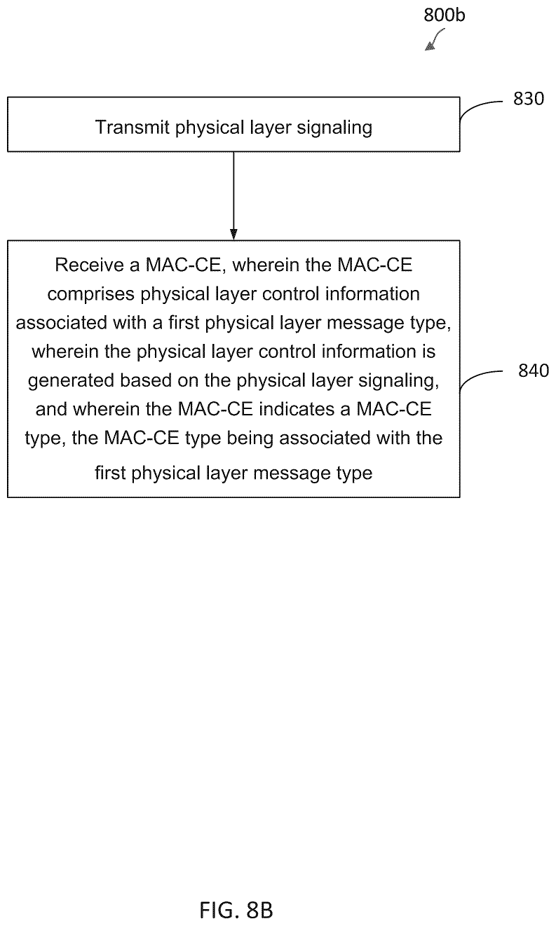

FIG. 8A is a flow diagram illustrating a wireless communication method 800a according to one or more aspects of the present disclosure. Aspects of the method 800a can be executed by a computing device (e.g., a processor, processing circuit, or other suitable component) of a first wireless communication device or other suitable means for performing the blocks. For instance, the first wireless communication device may be a UE (e.g., UE 115 or UE 600). The UE may utilize one or more components, such as the processor 602, the memory 604, the MAC-CE messaging module 608, the transceiver 610, the modem subsystem 612, the RF unit 614, the one or more antennas 616, or a combination thereof, to execute the blocks of method 800a. In another example, the first wireless communication device may be a network unit, such as a BS, RU, DU, or any other suitable network device. The network unit may utilize one or more components, such as the processor 702, the memory 704, the MAC-CE messaging module 708, the transceiver 710, the modem subsystem 712, the RF unit 714, the one or more antennas 716, or a combination thereof, to execute the blocks of method 800a. The method 800a may employ similar mechanisms as described in FIGS. 3-5C. As illustrated, the method 800a includes a number of enumerated blocks, but aspects of the method 800a may include additional blocks before, after, and in between the enumerated blocks. In some aspects, one or more of the enumerated blocks may be omitted or performed in a different order.

At block 810, the first wireless communication device communicates, with a second wireless communication device, physical layer signaling. In some aspects, the physical layer signaling includes data transmitted over a physical shared channel, such as a PDSCH, a PUSCH, or a PSSCH. In other aspects, the physical layer signaling comprises one or more reference signals, such as a CSI-RS. The physical layer signaling may be transmitted over a Uu link, or a sidelink, for example. In some aspects, the physical layer signaling may comprise downlink signaling from a network unit to a UE. In this regard, the first wireless communication device may comprise a UE, and the second wireless communication device may comprise a network unit. In another example, the physical layer signaling may comprise uplink signaling from a UE to a network unit. In this example, the first wireless communication device may comprise a network unit, and the second wireless communication device may comprise a UE. Aspects of block 810 may be similar or identical to action 302 of the method 300 illustrated in FIG. 3.

At block 820, the first wireless communication device communicates, with the second wireless communication device, a Medium Access Control-Control Element (MAC-CE). In one aspect, the MAC-CE comprises physical layer control information associated with a first physical layer message type. For instance, the physical layer control information may comprise HARQ ACK/NACK information, such as a HARQ ACK/NACK codebook. The physical layer message type may be a physical layer message type for carrying HARQ ACK/NACK information. In another example, the physical layer control information may comprise a CSI report, and the first physical layer message type may be a type for carrying the CSI report.

In another aspect, the physical layer control information is generated based on the physical layer signaling. For instance, the physical layer control information may comprise HARQ ACK/NACK information generated to indicate whether the physical layer signaling was successfully received and decoded. In another example, the physical layer signaling communicated at block 810 may comprise a reference signal, such as a CSI-RS. The physical layer control information may comprise a CSI report based on the CSI-RS.

In another aspect, the MAC-CE indicates a MAC-CE type, the MAC-CE type being associated with the first physical layer message type. In one example, the MAC-CE comprises, or is associated with, a logical channel ID (LCID). The LCID may comprise, or be represented by, an index or other value. The LCID may indicate that the MAC-CE carries physical layer control information. Further, the LCID may indicate which type of physical layer control information the MAC-CE carries, such as the first physical layer message type. In one aspect, there is a one-to-one correspondence between the LCID and the physical layer message type. In other words, the LCID may associated with the first physical layer message type specifically. In other embodiments, the LCID may be associated with a plurality of physical layer message types. This example is illustrated in FIG. 5A and described above.

In one example, one or more LCIDs may be associated with a priority value, and one or more physical layer message types may be associated with that same priority value. Accordingly, LCIDs for physical layer control messaging/signaling may be grouped based on their corresponding priority values. Further, one or more physical layer message types may be similarly grouped based on their corresponding priority values. This example is illustrated in FIG. 5C above.

In another aspect, the MAC-CE explicitly indicates a physical layer message type. For instance, the MAC-CE may include a subheader including a physical layer message type field. This field may indicate what type of physical layer message (and physical layer control information) is carried in the MAC-CE. This example is illustrated in FIG. 5B above.

Block 820 may include aspects of actions 304, 306, 308, and 310 of the scheme 300 illustrated in FIG. 3.

In some aspects, the method 800a further comprises transmitting the physical layer control information as a physical message over a physical channel. This step may be similar or identical to action 307 in the scheme 300 of FIG. 3. In this example, the first wireless communication device may communicate the physical layer control information both at the physical layer and in a MAC-CE. If the second wireless communication device is the device receiving the physical layer control information, the second wireless communication device may be able to attempt to decode the physical layer control information first at the physical layer, and then later at the MAC layer if the physical layer message cannot be decoded as a physical layer message.

In some aspects, the method 800a further comprises decoding a transport block comprising the MAC-CE, parsing the MAC-CE to extract the physical layer control information, and applying the physical layer control information for later physical layer signaling. This step map be similar or identical to actions 312, 314, 316, 318, and 320 in the scheme 300 illustrated in FIG. 3.

FIG. 8B is a flow diagram illustrating a wireless communication method 800b according to one or more aspects of the present disclosure. Aspects of the method 800b can be executed by a computing device (e.g., a processor, processing circuit, or other suitable component) of a second wireless communication device or other suitable means for performing the blocks. For instance, the second wireless communication device may be a UE (e.g., UE 115 or UE 600). The UE may utilize one or more components, such as the processor 602, the memory 604, the MAC-CE messaging module 608, the transceiver 610, the modem subsystem 612, the RF unit 614, the one or more antennas 616, or a combination thereof, to execute the blocks of method 800b. In another example, the second wireless communication device may be a network unit, such as a BS, RU, DU, or any other suitable network device. The network unit may utilize one or more components, such as the processor 702, the memory 704, the MAC-CE messaging module 708, the transceiver 710, the modem subsystem 712, the RF unit 714, the one or more antennas 716, or a combination thereof, to execute the blocks of method 800b. The method 800b may employ similar mechanisms as described in FIGS. 3-5C. As illustrated, the method 800b includes a number of enumerated blocks, but aspects of the method 800b may include additional blocks before, after, and in between the enumerated blocks. In some aspects, one or more of the enumerated blocks may be omitted or performed in a different order.

At block 830, the second wireless communication device transmits, to a first wireless communication device, physical layer signaling. In some aspects, the physical layer signaling includes data transmitted over a physical shared channel, such as a PDSCH, a PUSCH, or a PSSCH. In other aspects, the physical layer signaling comprises one or more reference signals, such as a CSI-RS. The physical layer signaling may be transmitted over a Uu link, or a sidelink, for example. In some aspects, the physical layer signaling may comprise downlink signaling from a network unit to a UE. In this regard, the second wireless communication device may comprise a UE, and the first wireless communication device may comprise a network unit. In another example, the physical layer signaling may comprise uplink signaling from a UE to a network unit. In this example, the second wireless communication device may comprise a network unit, and the first wireless communication device may comprise a UE. Aspects of block 830 may be similar or identical to action 302 of the method 300 illustrated in FIG. 3.

At block 840, the second wireless communication device receives, from the first wireless communication device, a Medium Access Control-Control Element (MAC-CE). In one aspect, the MAC-CE comprises physical layer control information associated with a first physical layer message type. For instance, the physical layer control information may comprise HARQ ACK/NACK information, such as a HARQ ACK/NACK codebook. The physical layer message type may be a physical layer message type for carrying HARQ ACK/NACK information. In another example, the physical layer control information may comprise a CSI report, and the first physical layer message type may be a type for carrying the CSI report.

In another aspect, the physical layer control information is generated based on the physical layer signaling. For instance, the physical layer control information may comprise HARQ ACK/NACK information generated to indicate whether the physical layer signaling was successfully received and decoded. In another example, the physical layer signaling transmitted at block 830 may comprise a reference signal, such as a CSI-RS. The physical layer control information may comprise a CSI report based on the CSI-RS.

In another aspect, the MAC-CE indicates a MAC-CE type, the MAC-CE type being associated with the first physical layer message type. In one example, the MAC-CE comprises, or is associated with, a logical channel ID (LCID). The LCID may comprise, or be represented by, an index or other value. The LCID may indicate that the MAC-CE carries physical layer control information. Further, the LCID may indicate which type of physical layer control information the MAC-CE carries, such as the first physical layer message type. In one aspect, there is a one-to-one correspondence between the LCID and the physical layer message type. In other words, the LCID may associated with the first physical layer message type specifically. In other embodiments, the LCID may be associated with a plurality of physical layer message types. This example is illustrated in FIG. 5A and described above.

In one example, one or more LCIDs may be associated with a priority value, and one or more physical layer message types may be associated with that same priority value. Accordingly, LCIDs for physical layer control messaging/signaling may be grouped based on their corresponding priority values. Further, one or more physical layer message types may be similarly grouped based on their corresponding priority values. This example is illustrated in FIG. 5C above.

In another aspect, the MAC-CE explicitly indicates a physical layer message type. For instance, the MAC-CE may include a subheader including a physical layer message type field. This field may indicate what type of physical layer message (and physical layer control information) is carried in the MAC-CE. This example is illustrated in FIG. 5B above.

Block 840 may include aspects of actions 304, 306, 308, and 310 of the scheme 300 illustrated in FIG. 3.

In some aspects, the method 800b further comprises transmitting the physical layer control information as a physical message over a physical channel. This step may be similar or identical to action 307 in the scheme 300 of FIG. 3. In this example, the first wireless communication device may communicate the physical layer control information both at the physical layer and in a MAC-CE. If the second wireless communication device is the device receiving the physical layer control information, the second wireless communication device may be able to attempt to decode the physical layer control information first at the physical layer, and then later at the MAC layer if the physical layer message cannot be decoded as a physical layer message.

In some aspects, the method 800b further comprises decoding a transport block comprising the MAC-CE, parsing the MAC-CE to extract the physical layer control information, and applying the physical layer control information for later physical layer signaling. This step map be similar or identical to actions 312, 314, 316, 318, and 320 in the scheme 300 illustrated in FIG. 3.

Other aspects of the present disclosure include:
Aspect 1. A method for wireless communication performed by a first wireless communication device, the method comprising: receiving, from a second wireless communication device, physical layer signaling; and transmitting, to the second wireless communication device, a Medium Access Control (MAC) layer control message, wherein: the MAC layer control message comprises physical layer control information associated with a first physical layer message type, the physical layer control information is generated based on the physical layer signaling, and the MAC layer control message indicates a MAC layer control message type, the MAC layer control message type being associated with the first physical layer message type.
Aspect 2. The method of claim 1, further comprising: receiving, from the second wireless communication device, second physical layer signaling, wherein the second physical layer signaling is based on the physical layer control information.
Aspect 3. The method of claim 2, wherein each of the physical layer signaling and the second physical layer signaling comprises at least one of a Physical Downlink Shared Channel (PDSCH) communication, a Downlink Control Information (DCI), a Physical Uplink Shared Channel (PUSCH) communication, an Uplink Control Information (UCI), or a CSI Reference Signal (CSI-RS).
Aspect 4. The method of claim 1, wherein: the physical layer control information comprises at least one of a Hybrid Automatic Repeat Request (HARQ) Acknowledgement/Non-Acknowledgement (ACK/NACK) codebook or a Channel State Information (CSI) report, and the first physical layer message type comprises at least one of a HARQ codebook type or a CSI report type.
Aspect 5. The method of claim 1, wherein the MAC layer control message further comprises an indication of a size of the MAC layer control message.
Aspect 6. The method of claim 5, wherein the indication of the size of the MAC layer control message indicates at least one of a number of octets in the MAC layer control message or a number of unused bits in a last octet of the MAC layer control message.
Aspect 7. The method of claim 1, wherein the MAC layer control message comprises an identifier.
Aspect 8. The method of claim 7, wherein the identifier indicates the first physical layer message type.
Aspect 9. The method of claim 7, wherein the identifier is associated with the first physical layer message type and a second physical layer message type.
Aspect 10. The method of claim 9, wherein the MAC layer control message comprises a subheader, wherein the subheader indicates the first physical layer message type.
Aspect 11. The method of claim 9, wherein the identifier is associated with a priority value, and wherein the first physical layer message type is also associated with the priority value.
Aspect 12. The method of claim 1, wherein the MAC layer control message further comprises a reference time associated with the physical layer control information.
Aspect 13. The method of claim 12, wherein the reference time indicates at least one of a generation time of the physical layer control information or an expiration time of the physical layer control information.
Aspect 14. The method of claim 1, wherein the first wireless communication device comprises a user equipment (UE), and wherein the MAC layer control message comprises a MAC control element (MAC-CE).
Aspect 15. The method of claim 1, wherein the first wireless communication device comprises a network unit, and wherein the MAC layer control message comprises a MAC-CE.
Aspect 16. A first wireless communication device, comprising: one or more memory devices; and
one or more processors in communication with the one or more memory devices, wherein the first wireless communication device is configured to perform the steps of any of aspects 1-15.
Aspect 17. A method for wireless communication performed by a second wireless communication device, the method comprising: transmitting, to a first wireless communication device, physical layer signaling; and receiving, from the first wireless communication device, a Medium Access Control (MAC) layer control message, wherein: the MAC layer control message comprises physical layer control information associated with a first physical layer message type, the physical layer control information is generated based on the physical layer signaling, and the MAC layer control message indicates a MAC layer control message type, the MAC layer control message type being associated with the first physical layer message type.
Aspect 18. The method of claim 17, further comprising: decoding, by the second wireless communication device, a transport block (TB) to obtain the MAC layer control message; and parsing the MAC layer control message to obtain the physical layer control information.
Aspect 19. A second wireless communication device, comprising: one or more memory devices; and one or more processors in communication with the one or more memory devices, wherein the second wireless communication device is configured to perform the steps of any of aspects 17 or 18.
Aspect 20. A first wireless communication device, comprising means for performing the steps of any of aspects 1-15.
Aspect 21. A second wireless communication device, comprising means for performing the steps of any of aspects 17 or 18.
Aspect 22. A non-transitory, computer-readable medium having program code recorded thereon, wherein the program code comprises instructions executable by one or more processors of a first wireless communication device to cause the first wireless communication device to perform the steps of any of aspects 1-15.
Aspect 23. A non-transitory, computer-readable medium having program code recorded thereon, wherein the program code comprises instructions executable by one or more processors of a second wireless communication device to cause the second wireless communication device to perform the steps of any of aspects 17 or 18.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other aspects and implementations are within the scope of the disclosure and appended claims. For instance, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for instance, a list of items prefaced by a phrase such as “at least one of” or “one or more of”) indicates an inclusive list such that, for instance, a list of [at least one of A, B, or C] means A or B or C or AB or AC or BC or ABC (e.g., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some aspects thereof, but rather, should be fully commensurate with that of the claims appended hereafter and their functional equivalents.

What is claimed is:

1. A first wireless communication device, comprising:
one or more memory devices; and
one or more processors associated with the one or more memory devices, wherein the first wireless communication device is configured to:
receive, from a second wireless communication device, physical layer signaling; and
transmit, to the second wireless communication device, a Medium Access Control (MAC) layer control message,
wherein:
the MAC layer control message comprises physical layer control information associated with a first physical layer message type,
the physical layer control information is generated based on the physical layer signaling, and
the MAC layer control message indicates a MAC layer control message type, the MAC layer control message type being associated with the first physical layer message type.

2. The first wireless communication device of claim 1, wherein the first wireless communication device is further configured to:
receive, from the second wireless communication device, second physical layer signaling, wherein the second physical layer signaling is based on the physical layer control information.

3. The first wireless communication device of claim 2, wherein each of the physical layer signaling and the second physical layer signaling comprises at least one of a Physical Downlink Shared Channel (PDSCH) communication, a Downlink Control Information (DCI), a Physical Uplink Shared Channel (PUSCH) communication, an Uplink Control Information (UCI), or a CSI Reference Signal (CSI-RS).

4. The first wireless communication device of claim 1, wherein:
the physical layer control information comprises at least one of a Hybrid Automatic Repeat Request (HARQ) Acknowledgement/Non-Acknowledgement (ACK/NACK) codebook or a Channel State Information (CSI) report, and
the first physical layer message type comprises at least one of a HARQ codebook type or a CSI report type.

5. The first wireless communication device of claim 1, wherein the MAC layer control message further comprises an indication of a size of the MAC layer control message.

6. The first wireless communication device of claim 5, wherein the indication of the size of the MAC layer control message indicates at least one of a number of octets in the MAC layer control message or a number of unused bits in a last octet of the MAC layer control message.

7. The first wireless communication device of claim 1, wherein the MAC layer control message comprises an identifier.

8. The first wireless communication device of claim 7, wherein the identifier indicates the first physical layer message type.

9. The first wireless communication device of claim 7, wherein the identifier is associated with the first physical layer message type and a second physical layer message type.

10. The first wireless communication device of claim 9, wherein the MAC layer control message comprises a subheader, wherein the subheader indicates the first physical layer message type.

11. The first wireless communication device of claim 9, wherein the identifier is associated with a priority value, and wherein the first physical layer message type is also associated with the priority value.

12. The first wireless communication device of claim 1, wherein the MAC layer control message further comprises a reference time associated with the physical layer control information.

13. The first wireless communication device of claim 12, wherein the reference time indicates at least one of a generation time of the physical layer control information or an expiration time of the physical layer control information.

14. The first wireless communication device of claim 1, wherein the first wireless communication device comprises a user equipment (UE), and wherein the MAC layer control message comprises a MAC control element (MAC-CE).

15. The first wireless communication device of claim 1, wherein the first wireless communication device comprises a network unit, and wherein the MAC layer control message comprises a MAC-CE.

16. A method for wireless communication performed by a first wireless communication device, the method comprising:
receiving, from a second wireless communication device, physical layer signaling; and
transmitting, to the second wireless communication device, a Medium Access Control (MAC) layer control message,
wherein:
the MAC layer control message comprises physical layer control information associated with a first physical layer message type,
the physical layer control information is generated based on the physical layer signaling, and
the MAC layer control message indicates a MAC layer control message type, the MAC layer control message type being associated with the first physical layer message type.

17. The method of claim 16, further comprising:
receiving, from the second wireless communication device, second physical layer signaling, wherein the second physical layer signaling is based on the physical layer control information,
wherein each of the physical layer signaling and the second physical layer signaling comprises at least one of a Physical Downlink Shared Channel (PDSCH) communication, a Downlink Control Information (DCI), a Physical Uplink Shared Channel (PUSCH) communication, an Uplink Control Information (UCI), or a CSI Reference Signal (CSI-RS).

18. The method of claim 16, wherein:
the physical layer control information comprises at least one of a Hybrid Automatic Repeat Request (HARQ) Acknowledgement/Non-Acknowledgement (ACK/NACK) codebook or a Channel State Information (CSI) report, and
the first physical layer message type comprises at least one of a HARQ codebook type or a CSI report type.

19. The method of claim 16, wherein the MAC layer control message further comprises an indication of a size of the MAC layer control message, wherein the indication of the size of the MAC layer control message indicates at least one of a number of octets in the MAC layer control message or a number of unused bits in a last octet of the MAC layer control message.

20. The method of claim 16, wherein the MAC layer control message comprises an identifier.

21. The method of claim 20, wherein the identifier indicates the first physical layer message type.

22. The method of claim 20, wherein the identifier is associated with the first physical layer message type and a second physical layer message type.

23. The method of claim 22, wherein the MAC layer control message comprises a subheader, wherein the subheader indicates the first physical layer message type.

24. The method of claim 22, wherein the identifier is associated with a priority value, and wherein the first physical layer message type is also associated with the priority value.

25. The method of claim 16, wherein the MAC layer control message further comprises a reference time associated with the physical layer control information, wherein the reference time indicates at least one of a generation time of the physical layer control information or an expiration time of the physical layer control information.

26. The method of claim 16, wherein the first wireless communication device comprises a user equipment (UE), and wherein the MAC layer control message comprises a MAC control element (MAC-CE).

27. A second wireless communication device, comprising:
one or more memory devices; and
one or more processors associated with the one or more memory devices, wherein the second wireless communication device is configured to:
transmit, to a first wireless communication device, physical layer signaling; and
receive, from the first wireless communication device, a Medium Access Control (MAC) layer control message,
wherein:
the MAC layer control message comprises physical layer control information associated with a first physical layer message type,
the physical layer control information is generated based on the physical layer signaling, and
the MAC layer control message indicates a MAC layer control message type, the MAC layer control message type being associated with the first physical layer message type.

28. The second wireless communication device of claim 27, wherein the second wireless communication device is further configured to:
decode a transport block (TB) to obtain the MAC layer control message; and
parse the MAC layer control message to obtain the physical layer control information.

29. A method for wireless communication performed by a second wireless communication device, the method comprising:
transmitting, to a first wireless communication device, physical layer signaling; and
receiving, from the first wireless communication device, a Medium Access Control (MAC) layer control message,
wherein:
the MAC layer control message comprises physical layer control information associated with a first physical layer message type,
the physical layer control information is generated based on the physical layer signaling, and
the MAC layer control message indicates a MAC layer control message type, the MAC layer control message type being associated with the first physical layer message type.

30. The method of claim 29, further comprising:
decoding, by the second wireless communication device, a transport block (TB) to obtain the MAC layer control message; and
parsing the MAC layer control message to obtain the physical layer control information.
